(19) United States
(12) Patent Application Publication
(10) Pub. No.: US 2012/0162794 A1
(43) Pub. Date: Jun. 28, 2012

(54) LENS MODULE

(75) Inventors: Kwang Chun LEE, Suwon (KR); Young Su Jin, Yongin (KR); Seong Jin Hong, Yongin (KR); Seok Cheon Lee, Suwon (KR)

(73) Assignee: SAMSUNG ELECTRO-MECHANICS CO., LTD., Suwon (KR)

(21) Appl. No.: 13/316,949

(22) Filed: Dec. 12, 2011

(30) Foreign Application Priority Data
Dec. 23, 2010 (KR) 10-2010-0133259

(51) Int. Cl. G02B 7/09

(52) U.S. Cl. 359/824

(57) ABSTRACT

There is provided a lens module. The lens module according to the present invention may include a lens unit including one or more lenses, each having a lens function part and a flange part forming a circumference of the lens function part; and a piezoelectric body disposed on the flange part so as to shield unnecessary light incident through the lens unit and performing autofocusing according to an application of voltage thereto.

### CROSS-REFERENCE TO RELATED APPLICATIONS

This application claims the priority of Korean Patent Application No. 10-2010-0133259 filed on Dec. 23, 2010, in the Korean Intellectual Property Office, the disclosure of which is incorporated herein by reference.

### BACKGROUND OF THE INVENTION

1. Field of the Invention

The present invention relates to a lens module, and more particularly, to a lens module capable of simultaneously implementing auto-focusing and unnecessary light shielding through having a simple structure.

2. Description of the Related Art

Recently, technology for various mobile devices having easy portability and improved voice information and data transmission and reception functions has been rapidly developed and distributed. In particular, a terminal in which a camera module having a camera function able to capture and store moving and still images of a subject, and transmitting the same to another party through integrating a camera module based on digital camera technology with a portable wireless communications terminal is mounted, has been commercialized.

With recent developments in technology, an optical mechanism such as a camera module for a small portable terminal, or the like, has been changed to have a structure capable of implementing various additional functions such as autofocusing, optical zoom, or the like, while being used with a high-pixel mechanism of 700 million pixels or more.

The optical mechanism implements a zoom function or autofocusing by changing a relative distance through a vertical transfer of a lens and includes a unit for vertically moving a lens or a lens barrel provided with the lens.

In particular, as a lens transfer unit for implementing autofocusing, an actuator has mainly been used. As representative types of actuator, there are provided a voice coiled actuator and a piezoelectric actuator.

However, the actuator is generally provided on the outside of the lens or the lens barrel to transfer the position of the lens or the lens barrel, resulting in an increase of the overall size of the camera module.

Therefore, it may be difficult to combine the camera module with a portable terminal due to a lack of mounting space for the camera module in a terminal body at the time of mounting the camera module in the portable terminal.

### SUMMARY OF THE INVENTION

An aspect of the present invention provides a lens module capable of implementing autofocusing and unnecessary light shielding while minimizing an increase in an overall size thereof.

According to an aspect of the present invention, there is provided a lens module, including: a lens unit including one or more lenses, each having a lens function part and a flange part forming a circumference of the lens function part; and a piezoelectric body disposed on the flange part so as to shield unnecessary light incident through the lens unit and performing autofocusing according to an application of voltage thereto.

The piezoelectric body may be disposed between the lenses stacked to be adjacent to each other.

The piezoelectric body may be disposed on a top surface of the flange part of an object side lens among the lenses.

The piezoelectric body may be disposed on a bottom surface of the flange part of an image side lens among the lenses.

The piezoelectric body may be disposed to cover the entire surface of the flange part.

The piezoelectric body may include two piezoelectric bodies and the two piezoelectric bodies are disposed in parallel on one surface of the flange part.

The piezoelectric body may have a lower electrode, a piezoelectric film, and an upper electrode sequentially stacked therein.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a vertical cross-sectional view of a camera including a lens module according to a first embodiment of the present invention;

FIG. 2 is a vertical cross-sectional view of the lens module according to the first embodiment of the present invention;

FIG. 3 is a partial perspective view of the lens module according to the first embodiment of the present invention;

FIG. 4 is a configuration diagram of a piezoelectric body in the lens module according to the first embodiment of the present invention;

FIGS. 5A to 5C are schematic cross-sectional view showing a poling procedure of the piezoelectric body in the lens module according to the first embodiment of the present invention;

FIG. 6 is a vertical cross-sectional view of a lens module according to a second embodiment of the present invention;

FIG. 7 is a vertical cross-sectional view of a lens module according to a third embodiment of the present invention; and

FIG. 8 is a vertical cross-sectional view of a lens module according to a fourth embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

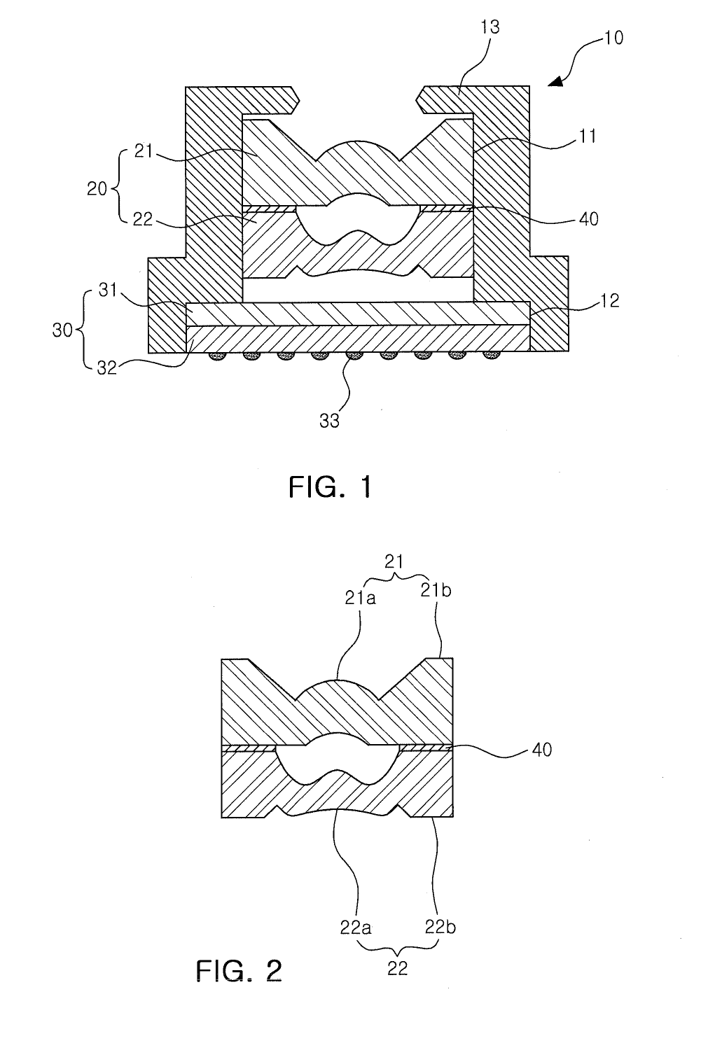

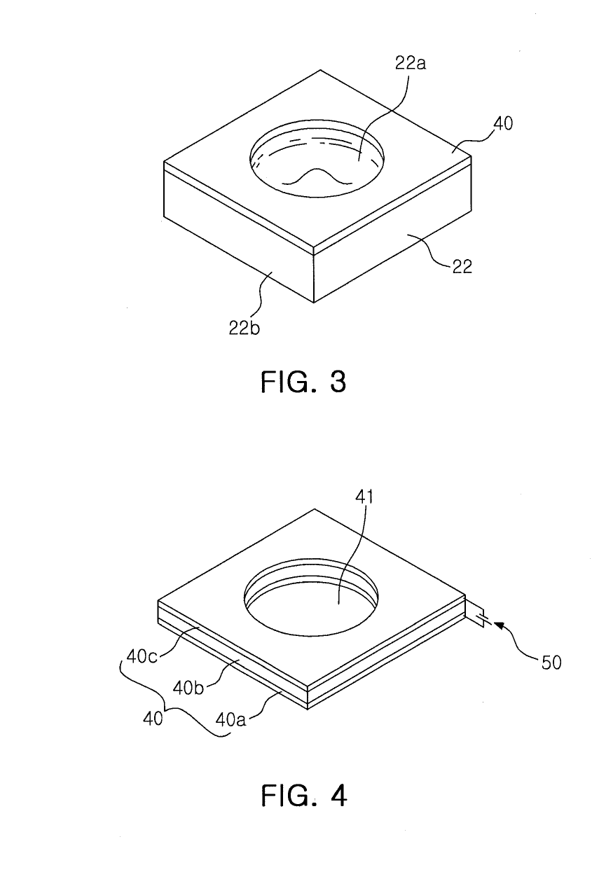

FIG. 1 is a vertical cross-sectional view of a camera including a lens module according to a first embodiment of the present invention. FIG. 2 is a vertical cross-sectional view of the lens module according to the first embodiment of the present invention. FIG. 3 is a partial perspective view of the lens module according to the first embodiment of the present invention. FIG. 4 is a configuration diagram of a piezoelectric body in the lens module according to the first embodiment of the present invention.

Referring to FIG. 1, a camera according to the first embodiment of the present invention includes a lens module 20 including one or more lenses stacked along an optical axis, an image sensor module 30 receiving light incident from the lens, a housing 10 receiving the lens module 20 and the image sensor module 30 therein, and a piezoelectric body 40 performing autofocusing of the camera.

Referring to FIG. 2, the lens module 20 includes a first lens 21 and a second lens 22 sequentially formed from an object side to an image side. Although the embodiment of the present invention has described and shown the case in which the lens module 20 includes two lenses, the embodiment of the present invention is not limited thereto and therefore, may include more than two lenses.

Although the present embodiment is described and shown that the lens module 20 has a structure in which a plurality of lenses are stacked, the embodiment of the present invention is not limited thereto. The lens module 20 may also have a structure in which the plurality of lenses are inserted and assembled into a lens barrel, and the structure of the lens module may be variously changed according to design conditions.

A lens may be made of a transparent material so as to have a spherical surface or a non-spherical surface and may collect and emit light incident from an object to form an optical image. As kinds of the lens, there are a plastic lens and a glass lens. The plastic lens formed by injecting a resin into a mold, pressing and hardening the resin to manufacture a wafer scale lens and then individualizing the lens has a low manufacturing cost and may be mass-produced. Meanwhile, the glass lens is advantageous for implementing high resolution;

however, it requires a complicated process and a high cost, and has a difficulty in implementing a lens shape, other than a spherical lens or a planar lens, due to the manufacturing thereof through cutting and grinding glass.

The embodiment of the present invention uses a plastic lens manufactured on a wafer scale. The first and second lenses 21 and 22 may include lens function parts 21a and 22a, respectively, each having a spherical surface or a non-spherical surface formed at the central portion thereof, and flange parts 21b and 22b forming circumferences of the lens function parts 21a and 22a, respectively.

The lens function parts 21a and 22a may have various shapes, such as a meniscus shape protruded or recessed towards an object side, a meniscus shape protruded or recessed towards an image side, a meniscus shape protruded towards the image side adjacent to the flange part while being recessed on the image side in the central portion thereof, or the like. In addition, the flange parts 21b and 22b may serve as spacers spacing the lens function parts from each other at the time stacking adjacent lenses.

The lens function part 21a of the first lens 21 has an open top portion to receive light incident from the object side, and the flange part 21b is covered by the housing 10 so as to shield light incident at an angle other than an effective incident angle.

The piezoelectric body 40 is disposed between the first lens 21 and the second lens 22, the piezoelectric body 40 performing the autofocusing of the camera according to the first embodiment of the present invention. A configuration of the piezoelectric body 40 will be described below.

The image sensor module 30 may be a chip scale package (CSP) including an image sensor chip 32 having an image region in which light having passed through the lens module 20 may form an image.

The chip scale package (alternatively, a chip size package), a new package type that has recently been developed and proposed, has more advantages, rather than a typical plastic package. The greatest advantage of the chip scale package is the package size thereof. According to a definition of international semiconductor association such as Joint Electron Device Engineering Council (JEDEC), Electronic Industry Association of Japan (EIAJ), or the like, the chip scale package is generally a classification name for a package having a size about 1.2 times larger than the size of a chip. The chip scale package has mainly been used for products requiring miniaturization and mobility such as a digital camcoder, a mobile phone, a notebook computer, a memory card, or the like. The chip scale package has semiconductor devices mounted therein, such as a digital signal processor (DSP), an application specific integrated circuit (ASIC), a microcontroller, or the like. In addition, the use of the chip scale package in which a memory device, such as a dynamic random access memory (DRAM), a flash memory, or the like, is mounted has been expanded.

The image sensor chip 32 is a device receiving light and converting the received light into an electrical signal. The types of the image sensor chip 32 may be classified into a charge coupled device (CCD) sensor chip and a complementary metal oxide semiconductor (CMOS) sensor chip according to the operation and manufacturing method thereof. The CCD sensor chip, which is based on an analog circuit, uses a scheme of distributing light incident from the lens module 20 to several cells so as to allow each cell to store a charge for the light, determining a degree of contrast by using the size of the charge, and then, transmitting the light to a conversion device to represent colors. The CCD sensor chip may allow for a clear image but requires increased data storage capacity and power consumption, such that the CCD sensor chip is mainly used for a high definition digital camera. The CMOS sensor chip is a chip in which an analog signal processing circuit and a digital signal processing circuit are integrated with a semiconductor. The CMOS sensor chip requires only 1/10 of power consumption as compared with the CCD sensor chip. In addition, the CMOS sensor chip is formed such that necessary parts are generally configured in a single chip, thereby allowing for the miniaturization of a product. Due to the recent improvement of technology, the use of the CMOS sensor chip having high definition characteristics in addition to the above advantages has been expanded to several applications, such as a digital camera, a camera phone, a portable multimedia player (PMP), or the like.

The image sensor chip 32 includes a wafer having an image sensor on a top surface thereof, and a bottom surface of the image sensor chip 32 is provided with a connection member 33 so as to be connected to a terminal of a main substrate (not shown) on which the camera is mounted.

The connection member 33 may be made of a conductive paste, in particular, a solder paste or a silver-epoxy (Ag-epoxy) resin. In addition, the connection member 32c may have a shape of a solder ball.

Meanwhile, the main substrate may be a printed wiring board (PWB), a flexible PWB, or a rigid flexible PWB. Generally, the PWB is referred to a circuit board formed by densely mounting several types of components on a flat board made of phenol resin or epoxy resin and densely fixing circuits connecting the respective components to a surface of the resin-based flat board. The PWB may be manufactured by attaching a thin copper plate or the like to one side of a phenol resin insulating plate, an epoxy resin, or the like, and then performing etching along a wiring pattern of a circuit (removal of portions of the copper plate through corrosion with only a circuit line remaining) to form a necessary circuit, and creating holes for attachedly mounting components. The types of the PWB may be classified into a single sided substrate, a double-sided substrate, a multi-layer substrate, or the like, according to the number of wiring circuit surfaces. As the number of layers is increased, the PWB has excellent mounting ability and thus, may be adopted for high precision products. In addition, when the circuit board needs to be transferred and needs to be bent at the time of the insertion and configuration of components, the circuit board manufactured to have flexibility is referred to a flexible PWB. Meanwhile, the rigid flexible PWB in which a rigid portion and a flexible portion are coupled with each other may also be used.

The top surface of the image sensor chip 32 may be provided with a cover glass 31. One surface of the cover glass 31 is subjected to IR coating, such that the cover glass 31 may serve as an IR cut-off filter.

The IR cut-off filter may remove an optical signal in an infrared region before the optical signal is inputted to the image sensor through the lens, to allow the image sensor to receive only an optical signal in a visible ray region, to thereby allow an image approximating to a real color.

The housing 10 has an inner space and includes open top and bottom portions. In detail, the housing 10 may include a first receiving part 11 receiving the lens module 20 and a second receiving part 12 receiving the image sensor module 30. A horizontal cross sectional area of the first receiving part 11 may be formed to be smaller than that of the second receiving part 12.

An inner space of the first receiving part 11 receives the lens module 20. The lens module 20 may be directly inserted into the first receiving part 11 in the state in which the first lens 21, the piezoelectric body 40, and the second lens 22 are bonded to one another. Alternatively, a lens barrel in which the first lens 21, the piezoelectric body 40, and the second lens 22 are accommodated may be inserted into the first receiving part 11, along an inner surface of the first receiving part 11.

A length of the first receiving part 11 in an optical axis direction may be greater than a length of the lens module 20 in the optical axis direction in such a manner that the lens module 20 and the image sensor module 30 are spaced apart from each other by a predetermined interval. The embodiment of the present invention is not limited thereto. A spacer spacing between the lens module 20 and the image sensor module 30 by a predetermined interval may be disposed between the lens module 20 and the image sensor module 30.

The housing 10 may include a capping part 13 formed to be bent in the first receiving part 11 so as to cover the flange part 21b of the first lens 21 of the lens module 20.

The lens module 20 may be slidably coupled with the first receiving part 11 so as to be vertically moved along the inner surface of the first receiving part 11 by the operation of the piezoelectric body 40. In detail, the lens module 20 may be fixed to the housing 10 through filling an adhesive between the second lens 22 and the first receiving 11. When the piezoelectric body 40 extends in a thickness direction by applying voltage to the piezoelectric body 40, the second lens 22 fixed to the first receiving part 11 may not be vertically moved and thus, the first lens 11 may be relatively vertically moved along the optical axis. In this case, the capping part 13 and the flange part 21b may be spaced apart from each other by a predetermined interval in consideration of the vertical movement of the lens module 20.

The coupling between the lens module 20 and the housing 10 is not limited thereto. Various coupling may be applied such as the cases in which the first lens 21 is fixed to the housing 10 and the second lens 22 may move downwardly along the inner surface of the first receiving part 11, between the image sensor module 30 and the second lens 22 in association with the extension in the thickness direction of the piezoelectric body 40, or the like.

Referring to FIGS. 3 and 4, the piezoelectric body 40 is disposed between the first lens 21 and the second lens 22.

In particular, the piezoelectric body 40 maybe disposed between a bottom surface of the flange part 21b of the first lens 21 and a top surface of the flange part 22b of the second lens 22. In this configuration, the piezoelectric body 40 may be disposed to cover the entire flange part. In the embodiment of the present invention, when the lens module includes two or more lenses, the piezoelectric body 40 maybe disposed between lenses stacked to be adjacent to each other.

The piezoelectric body 40 may be displaced in the thickness direction (optical-axis direction) according to the application of voltage to perform the autofocusing of the lens module 20. The center of the piezoelectric body 40 is provided with an opening 41 so as to expose the lens function part 22a of the second lens 22.

The piezoelectric body 40 has a lower electrode 40a, a piezoelectric film 40b, and an upper electrode 40c sequentially stacked therein. The upper electrode 40c and the lower electrode 40a may supply driving voltage to the piezoelectric film 40b to cause the displacement of the piezoelectric body 40.

In this case, autofocusing may be controlled according to the displacement of the piezoelectric body 40 and the displacement of the piezoelectric body 40 may be controlled by applied voltage strength, the volume of the piezoelectric body, or the like.

The lower electrode 40a may be made of a single conductive metal material. Alternatively, the lower electrode 40 may includes two thin metal layers made of titanium (Ti) and platinum (Pt).

The piezoelectric film 40b may be a material that may convert electrical energy into mechanical energy or vice versa. That is, when the piezoelectric film 40b may refer to a material, in which polarization is induced when mechanical pressure is applied thereto from the outside or mechanical deformation is generated due to external magnetic field.

The piezoelectric film 40b is formed on the lower electrode 40a. The material of the piezoelectric film 40b may be lead zirconate titanate (Pb (Zr, Ti)O₃:PZT) ceramic, which may have a perovskite crystal structure. In addition, the piezoelectric film 40b may need a poling procedure so as to have the above-mentioned characteristics.

The upper electrode 40c is formed on the piezoelectric film 40b and may be made of any one of Pt, Au, Ag, Ni, Ti, Cu, and the like.

The piezoelectric body 40 formed as described above may serve as a light shielding film shielding unnecessary light incident on the lens module 20 while performing the autofocusing by the displacement thereof. In this case, in order to act as the light shielding film, a material containing a black component may be coated on one surface of the piezoelectric body 40.

Although the piezoelectric body 40 according to the embodiment of the present invention has described and shown the case in which the upper electrode 40c and the lower electrode a are formed on the top surface and the bottom surface of the piezoelectric film 40b, the embodiment of the present invention is not limited thereto, and the design of the piezoelectric body 40 may be variously changed. For example, the piezoelectric body 40 may be formed of only the piezoelectric film and the piezoelectric film may be formed on the inner surface of the first receiving part 11 in such a manner that the upper electrode and the lower electrode are connected to the piezoelectric film.

In addition, the piezoelectric body 40 may be formed by various methods, such as directly coating the piezoelectric body to the flange part of the lens or the manufacturing and bonding of a separate piezoelectric body.

The application of voltage to the piezoelectric body 40 may be performed by directly connecting the main substrate having the camera mounted thereon with the upper electrode 40c and the lower electrode 40a of the piezoelectric body 40 or may be performed by electrically connecting the piezoelectric body 40 with the main substrate through a wafer on which the image sensor of the image sensor chip 32 is mounted. In this case, for the electrical connection of the piezoelectric body 40, various methods such as forming the housing 10 using a conductive material, coating one surface of the housing 10 with the conductive material, forming a wiring pattern made of the conductive material, or the like, may be used.

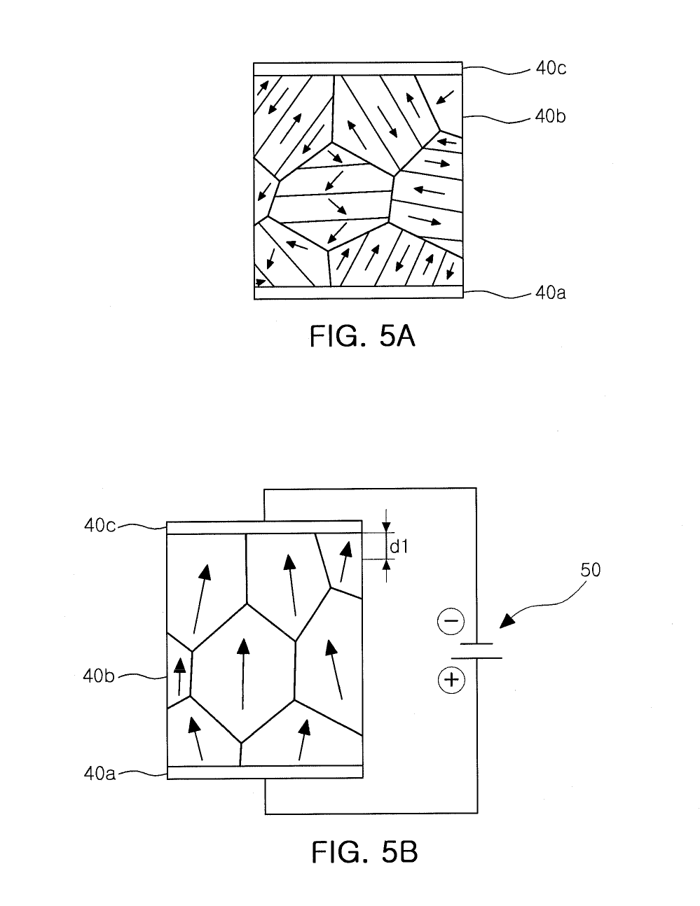

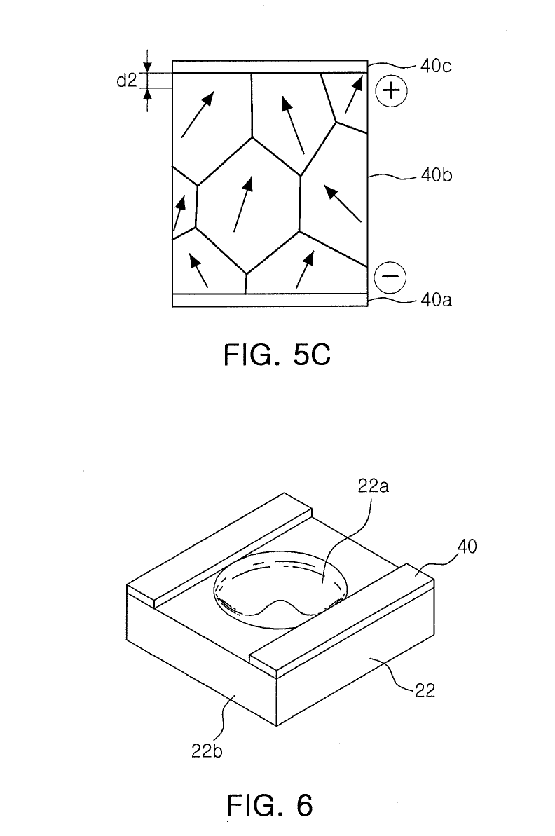

FIGS. 5A to 5C are schematic cross-sectional view showing a poling procedure of the piezoelectric body in the lens module according to the first embodiment of the present invention.

Referring to FIGS. 5A to 5C, when the upper and lower electrodes 40c and 40a disposed on the top portion and the bottom portion of the piezoelectric film 40b and a direct current (DC) power 50 are connected to generate DC voltage, polarities may be generated in the piezoelectric film 40b due to the direct current (DC) power 50.

That is, generating the DC voltage in the piezoelectric film 40b may be referred to as a poling procedure. Hereinafter, the poling procedure will be described below.

FIG. 5A is a cross-sectional view showing an inner structure of the piezoelectric body 40 in an initial state thereof. The piezoelectric film 40b in the initial state thereof may be non-polarized.

In the initial state of the polycrystalline piezoelectric film 40b, the inside of each crystal grain is generally divided into several polarizations in which individual polarization directions thereof are different. In this state, the entirety of polarization is offset so as not to be exhibited to the outside.

That is, since the entirety of polarization is not formed in the initial state of the piezoelectric film 40b, polarization may not induced when mechanical pressure is applied thereto from the outside or mechanical deformation may not be generated due to external magnetic field.

Therefore, as shown in FIG. 5B, the polarization may be induced by connecting the upper and lower electrodes 40c and 40a of the piezoelectric film 40b present in the initial state thereof and the direct current (DC) power 50.

That is, when the DC voltage is applied to the piezoelectric body 40 in the initial state thereof, polarization may occur in the piezoelectric film 40b and the length d1 of crystals of the piezoelectric film 40b may be extended in polarization directions.

Thereafter, the applied DC voltage is removed, and the inner structure of the piezoelectric body 40 from which the DC voltage is removed is shown in FIG. 5C.

FIG. 5C illustrates a change of the piezoelectric body 40, in which the piezoelectric body 40 extends along a polarization axis, as compared to the initial state thereof shown in FIG. 5A.

That is, even in a case in which the DC voltage is applied to the piezoelectric body 40 in the initial state thereof and then removed, the entirety of the piezoelectric body 40 maintains a polarized state without returning to the original state thereof.

This is because that remnant strain d2 and remnant polarization are generated in the piezoelectric film 40b due to the poling procedure.

In this case, the remnant strain d2 refers a state change of a crystal grain due to the poling procedure.

Therefore, positive (+) charge and negative (−) charge are generally collected to the top portion of the piezoelectric film 40b.

The piezoelectric film 40b subjected to the poling procedure is more densified and has more excellent electrical characteristics to perform the function of the piezoelectric body 40 according to the embodiment of the present invention.

FIG. 6 is a vertical cross-sectional view of a lens module according to a second embodiment of the present invention.

The lens module according to the second embodiment of the present invention, shown in FIG. 6, relates to a modified example of a piezoelectric body shape and components thereof, other than the piezoelectric body shape are the same as those of the lens module according to the first embodiment of the present invention shown in FIGS. 1 to 3. Therefore, the detailed description thereof will be omitted. Hereafter, the difference between the first embodiment of the present invention and the third embodiment of the present invention will be mainly described below.

Referring to FIG. 6, in the lens module 20 according to the second embodiment of the present invention, two piezoelectric bodies 40 are disposed between the first lens 21 and the second lens 22, and in particular, are disposed between the bottom surface of the flange part 21b of the first lens 21 and the top surface of the flange part 22b of the second lens 22. The two piezoelectric bodies 40 are disposed in parallel between these flange parts.

That is, two piezoelectric bodies 40 are disposed along sides of a quadrangular lens facing each other, on the top surface flange part 22b of the second lens 22. According to the embodiment of the present invention, a used amount of the piezoelectric body 40 may be smaller but the vertical movement effect of the lens may be reduced, as compared with the case of the first embodiment of the present invention.

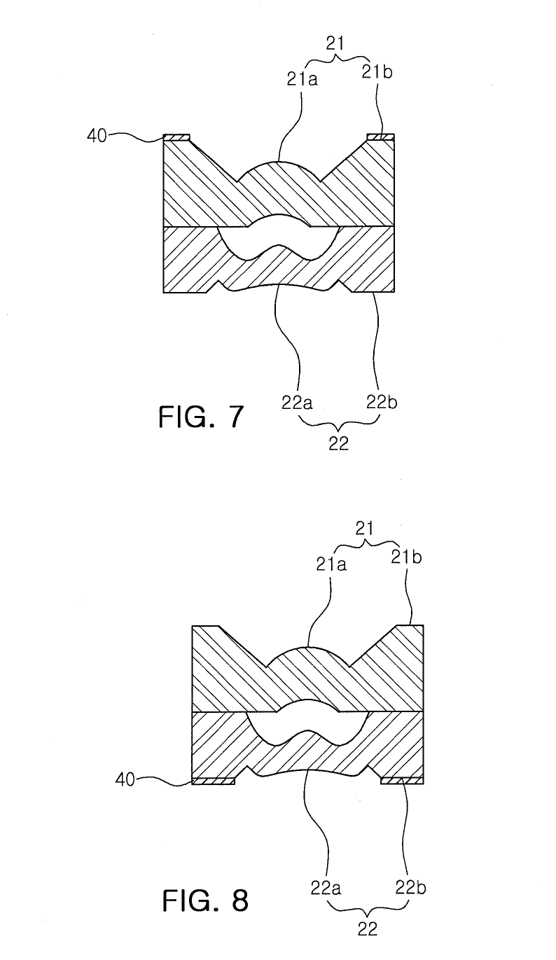

FIG. 7 is a vertical cross-sectional view of a lens module according to a third embodiment of the present invention. FIG. 8 is a vertical cross-sectional view of a lens module according to a fourth embodiment of the present invention.

The lens modules according to the third and fourth embodiments of the present invention shown in FIGS. 7 and 8 relate to modified examples of the disposition position of the piezoelectric body and components thereof, other than the disposition position of the piezoelectric body are the same as those of the lens module according to the first embodiment of the present invention shown in FIG. 2. Therefore, the detailed description thereof will be omitted. Hereafter, the difference between the first embodiment of the present invention and the third embodiment of the present invention will be mainly described below.

Referring to FIGS. 7 and 8, the lens module 20 according to the third and fourth embodiments of the present invention includes the first lens 21 and the second lens 22 sequentially formed from the object side to the object side.

As shown in FIG. 7, in the third embodiment of the present invention, the piezoelectric body 40 is disposed on the top surface of the flange part 21b of the first lens 21.

As shown in FIG. 8, in the fourth embodiment of the present invention, the piezoelectric body 40 may be disposed on the bottom surface of the flange part 22b of the second lens 22.

As set forth above, the exemplary embodiment of the present invention can realize the autofocusing and the unnecessary light shielding while minimizing the increase in the overall size.

Although the embodiments of the present invention have been described in detail, they are only examples. It will be appreciated by those skilled in the art that various modifications and other equivalent embodiments are possible from the present invention, however, the present invention should be seen as encompassing all inventions within the technical spirit of the present invention. For example, the disposition position of the piezoelectric body or the electrical connection method of the piezoelectric body, according to the embodiments of the present invention, is merely illustrative, and therefore, various disposition structures of the piezoelectric body may be applied and the electrical connection of the piezoelectric body may be performed by various methods. Accordingly, the actual technical scope of protection of the present invention must be determined by the spirit of the appended claims.

What is claimed is:

1. A lens module, comprising:
a lens unit including one or more lenses, each having a lens function part and a flange part forming a circumference of the lens function part; and
a piezoelectric body disposed on the flange part so as to shield unnecessary light incident through the lens unit and performing autofocusing according to an application of voltage thereto.

2. The lens module of claim 1, wherein the piezoelectric body is disposed between the lenses stacked to be adjacent to each other.

3. The lens module of claim 1, wherein the piezoelectric body is disposed on a top surface of the flange part of an object side lens among the lenses.

4. The lens module of claim 1, wherein the piezoelectric body is disposed on a bottom surface of the flange part of an image side lens among the lenses.

5. The lens module of claim 1, wherein the piezoelectric body is disposed to cover the entire surface of the flange part.

6. The lens module of claim 1, wherein the piezoelectric body includes two piezoelectric bodies and the two piezoelectric bodies are disposed in parallel on one surface of the flange part.

7. The lens module of claim 1, wherein the piezoelectric body has a lower electrode, a piezoelectric film, and an upper electrode sequentially stacked therein.
